(19) United States
(12) Patent Application Publication
(10) Pub. No.: US 2006/0290622 A1
(43) Pub. Date: Dec. 28, 2006

(54) ACTIVE MATRIX DISPLAY DEVICE AND METHOD OF DRIVING ACTIVE MATRIX DISPLAY DEVICE

(76) Inventor: Hirondo NAKATOGAWA, Kumagaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/426,490

(22) Filed: Jun. 26, 2006

(30) Foreign Application Priority Data
Jun. 27, 2005 (JP) 2005-186762

(51) Int. Cl. G09G 3/32

(52) U.S. Cl. 345/82

(57) ABSTRACT

There are provided pixel units arrayed in a matrix, and a signal line driving circuit. The signal line driving circuit divides a 1 frame into a first period in which a video signal is supplied to the pixel unit of a high gray level and a second period in which a video signal is supplied to the pixel unit of a low gray level, supplies in the first period a video signal current, which has a current value that is A-times (A>0) higher than a current value corresponding to high-gray-level display, to the pixel unit of the high gray level, and supplies in the second period a video signal current, which has a current value that is N-times (N>A) higher than a current value corresponding to low-gray-level display, to the pixel unit of the low gray level, thus writing the video signal in the pixel unit.

CROSS-REFERENCE TO RELATED APPLICATIONS

This application is based upon and claims the benefit of priority from prior Japanese Patent Application No. 2005-186762, filed Jun. 27, 2005, the entire contents of which are incorporated herein by reference.

### BACKGROUND OF THE INVENTION

1. Field of the Invention

The present invention relates to an active matrix display device, and more particularly to an active matrix display device that executes signal write using a current signal, and to a method of driving the active matrix display device.

2. Description of the Related Art

In recent years, there has been an increasing demand for a flat-screen display device that is typified by a liquid crystal display device, which has advantageous features of small thickness, light weight and low power consumption. In particular, an active matrix display device, in which each pixel is provided with a pixel switch that has a function of electrically separating an on-pixel and an off-pixel and holding a video signal to the on-pixel, is capable of achieving a good display quality without crosstalk between adjacent pixels. Thus, the active matrix display device has recently been applied to various displays including displays of portable information devices.

As such flat-screen active matrix display devices, organic electroluminescence (hereinafter referred to as EL) display devices have attracted attention and have widely been researched and developed as self-luminous displays. The organic EL display device does not require the provision of a backlight, which makes it difficult to reduce the thickness and weight of the device. In addition, since the organic EL display device has high responsivity, it is suitable for reproduction of motion video. Moreover, since the brightness of the organic EL display device does not decrease at low temperatures, it can be used even in cold regions.

The organic EL display device includes a plurality of pixels which are arrayed in a matrix. Each pixel includes an organic EL element functioning as a display element, and a pixel circuit which supplies a driving current to the display element. The organic EL display device performs a display operation by controlling the emission light luminance of the display elements. The pixel circuit includes, for example, a driving transistor and an output switch, which are connected in series to the organic EL element, and a diode-connected switch which is connected between the gate and the drain of the driving transistor and holds a gate potential corresponding to a video signal. These driving transistor, output switch and diode-connected switch are composed of, for instance, thin-film transistors.

For example, as disclosed in Jpn. Pat. Appln. KOKAI Publication No. 2003-122303, there is known an organic EL display device wherein image information is supplied to a pixel circuit by a current signal. KOKAI No. 2003-122303 discloses such a configuration that a current, which has an N-times higher value than a current supplied to the EL element, and the time of light emission is reduced to 1/N. According to this display device, the value of a video signal is set to be N-times higher than a desired value and the time for current supply to the display element is set at 1/N. Thereby, a desired driving current can be supplied to the display element.

In the above-described device, however, a current which is N-times higher than the driving current is uniformly supplied as the video signal. It is thus necessary to enhance the performance of a data line driving circuit so as to be capable of coping with the case of high-gray-level display. This leads to an increase in manufacturing cost. Furthermore, undesired power consumption will occur.

### BRIEF SUMMARY OF THE INVENTION

The present invention has been made in consideration of the above-described problems, and its object is to provide an active matrix display device which can perform a good display operation without being affected by a wiring capacitance, and can suppress power consumption, and a method of driving the active matrix display device.

According to an aspect of the invention, there is provided an active matrix display device comprising: a plurality of pixel units which are arrayed in a matrix on a display region of a substrate, each pixel unit including a display element;

a plurality of scan signal lines which are connected to respective rows of the pixel units;

a plurality of video signal lines which are connected to respective columns of the pixel units;

a scan line driving circuit which supplies scan signals to the scan signal lines; and

a signal line driving circuit which divides a 1 frame into a first period in which a video signal is supplied to the pixel unit of a high gray level and a second period in which a video signal is supplied to the pixel unit of a low gray level, supplies in the first period a video signal current, which has a current value that is A-times (A>0) higher than a current value corresponding to high-gray-level display, to the pixel unit of the high gray level, and supplies in the second period a video signal current, which has a current value that is N-times (N>A) higher than a current value corresponding to low-gray-level display, to the pixel unit of the low gray level, thus writing the video signal in the pixel unit.

According to another aspect of the invention, there is provided a method of driving an active matrix display device including a plurality of pixel units which are arrayed in a matrix on a display region of a substrate, each pixel unit including a display element, a plurality of scan signal lines which are connected to respective rows of the pixel units, a plurality of video signal lines which are connected to respective columns of the pixel units, a scan line driving circuit which supplies scan signals to the scan signal lines, and a signal line driving circuit which supplies video signals to the video signal lines, the method comprising:

dividing a 1 frame into a first period in which a video signal is supplied to the pixel unit of high-gray-level display and a second period in which a video signal is supplied to the pixel unit of low-gray-level display;

supplying and writing in the first period a video signal current, which has a current value that is A-times (A>0) higher than a current value corresponding to the high-gray-level display, in the pixel unit of the high-gray-level display; and

supplying and writing in the second period a video signal current, which has a current value that is N-times (N>A) higher than a current value corresponding to the low-gray-level display, in the pixel unit of the low-gray-level display.

According to the above mentioned construction, there can be provide an active matrix display device which can perform a good display operation without being affected by a wiring capacitance, and can suppress power consumption, and a method of driving the active matrix display device.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view that schematically shows an organic EL display device according to an embodiment of the present invention;

FIG. 2 is a plan view that schematically shows an equivalent circuit of a display element of the organic EL display device;

FIG. 3 is a view showing a driving unit of a signal line driving circuit of the organic EL display device;

FIG. 4 is a timing chart of output signals of the signal line driving circuit and scan line driving circuit of the organic EL display device; and

FIG. 5 is a plan view showing an equivalent circuit of a display pixel of the organic EL display device.

### DETAILED DESCRIPTION OF THE INVENTION

An embodiment of the present invention will now be described in detail with reference to the accompanying drawings. In this embodiment, an organic EL display device is described by way of example.

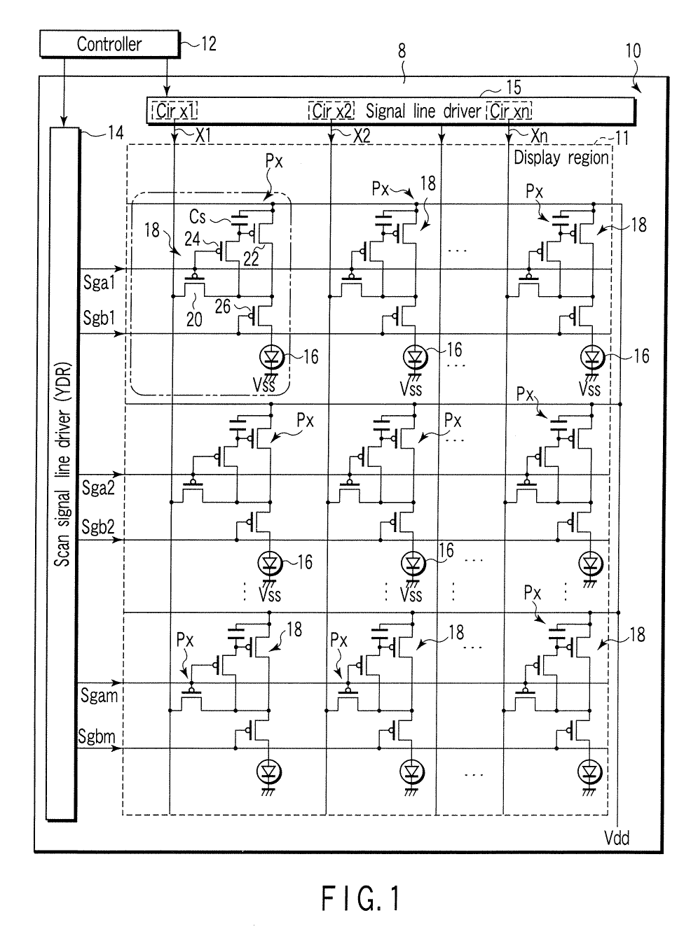

As is shown in FIG. 1, the organic EL display device is constructed as an active matrix display device with a large size of 10 inches or more. The organic EL display device includes an organic EL panel 10 and a controller 12 that controls the organic EL panel 10.

The organic EL panel 10 includes (m×n) display pixels Px which are arrayed in a matrix on an insulating substrate 8 such as a glass plate and constitute a display region 11; an m-number of first scan lines Sga (1 to m) and an m-number of second scan lines Sgb (1 to m), which are independently connected to respective rows of the display pixels Px; an n-number of video signal lines (1 to n) which are connected to respective columns of the display pixels Px; a scan line driving circuit (YDR) 14 which successively drives the first and second scan lines Sga (1 to m) and Sgb (1 to m) in units of a row of the display pixels; and a signal line driving circuit (XDR) 15 which drives a plurality of video signal lines X (1 to n). The scan line driving circuit 14 and signal line driving circuit 15 are integrally formed on the insulating substrate 8 on an outside area of the display region 11.

Each display pixel Px, which functions as a pixel unit, includes a display element including an optical active layer between opposed electrodes, and a pixel circuit 18 which supplies a driving current to the display element. The display element is, for example, a self-luminous element. In this embodiment, an organic EL element 16, which includes at least an organic light-emitting layer as an optical active layer, is used as the display element.

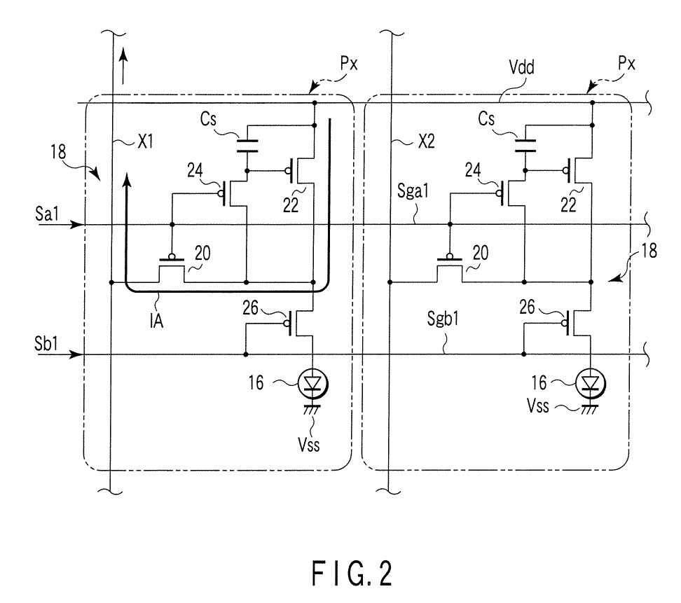

FIG. 2 shows an equivalent circuit of the display pixel Px. The pixel circuit 18 is a current-driving-type pixel circuit which controls light emission of the organic EL element 16 in accordance with a video signal which is composed of a current signal. The pixel circuit 18 includes a pixel switch 20, a driving transistor 22, a first switch 24, an output switch 26 and a storage capacitance Cs. In this embodiment, the pixel switch 20, driving transistor 22, first switch 24 and output switch 26 are composed of thin-film transistors of the same conductivity type, e.g. P-channel type. In the embodiment, all the thin-film transistors of the pixel circuit 18 are formed in the same fabrication steps with the same structure. Specifically, these transistors are top-gate type thin-film transistors using polysilicon as semiconductor layers.

The driving transistor 22, output switch 26 and organic EL element 16 are connected in series in the named order between a voltage supply line Vdd and a reference voltage supply line Vss. The reference voltage supply line Vss and voltage supply line Vdd are set at, e.g. −9 V and +6 V, respectively. A first terminal (the source in this example) of the driving transistor 22 is connected to the voltage supply line Vdd. One electrode (the cathode in this example) of the organic EL element 16 is connected to the reference voltage supply line Vss. The source of the output switch 26 is connected to a second terminal (the drain) of the driving transistor 22. The drain of the output switch 26 is connected to the anode of the organic EL element 16. The gate of the output switch 26 is connected to the second scan line Sgb.

The driving transistor 22 outputs a light emission current with a current amount, which corresponds to a video signal, to the organic EL element 16. The output switch 26 is on/off controlled (i.e. rendered conductive/non-conductive) by a control signal Sb (1 to m) from the second scan line Sgb, thereby controlling connection/disconnection between the driving transistor 22 and the organic EL element 16.

The storage capacitance Cs is connected between the first terminal (source) and a control terminal (gate) of the driving transistor 22. The storage capacitance Cs holds a gate control potential of the driving transistor 22, which is determined by the video signal. The pixel switch 20 is connected between the associated video signal line X (1 to n) and the drain of the driving transistor 22. The gate of the pixel switch 20 is connected to the first scan line Sga. Responding to a control signal Sa (1 to m) that is supplied from the first scan line Sga, the pixel switch 20 takes in a signal line current as a gradation current from the associated video signal line X (1 to n).

The first switch 24 is connected between the drain and the gate of the driving transistor 22. The gate of the first switch 24 is connected to the first scan line Sga. In response to the control signal Sa (1 to m) from the first scan line Sga, the first switch 24 is on/off controlled, thereby controlling connection/disconnection between the gate and drain of the driving transistor 22 and suppressing current leak from the storage capacitance Cs.

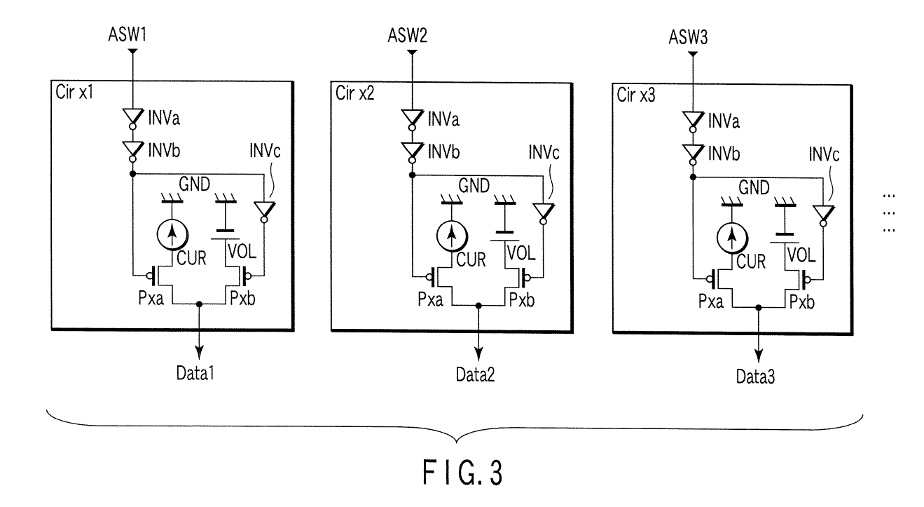

As is shown in FIG. 1 and FIG. 3, the signal line driving circuit 15 includes a plurality of driving units Cir X (1 to n), each of which is connected to one end of the associated video signal line X (1 to n). Each driving unit Cir X (1 to n) includes a current source CUR, a voltage source VOL, a pair of switches Pxa and Pxb which are composed of transistors, and three inverters INVa, INVb and INVc. As will be described later, the current source CUR supplies a video signal current corresponding to a gradation to the display pixel Px. In this case, the video signal current to be supplied is set at a predetermined ratio to a light emission current value in accordance with the gradation. The voltage source VOL supplies a video signal voltage corresponding to black display to the display pixel Px.

The current source CUR and voltage source VOL are connected in parallel. Specifically, the current source CUR is connected to the video signal line X via the switch Pxa, and the voltage source VOL is connected to the video signal line X via the switch Pxb. The switch Pxa has a source connected to the current source CUR, and a drain connected to the video signal line X. The gate of the switch Pxa is controlled on the basis of a gradation determination signal ASW (1 to m) which is supplied from the signal line driving circuit 15 via the two inverters INVa and INVb. Thus, the gate of the switch Pxa is supplied with a signal of the same polarity as the gradation determination signal ASW. The switch Pxa is turned on (conductive) and off (non-conductive), thereby to control connection/disconnection of the current source CUR to the video signal line X.

The switch Pxb has a source connected to the voltage source VOL, and a drain connected to the video signal line X. The gate of the switch Pxb is controlled on the basis of a gradation determination signal ASW (1 to m) which is supplied from the signal line driving circuit 15 via the three inverters INVa, INVb and INVc. Thus, the gate of the switch Pxb is supplied with a signal of a polarity opposite to the polarity of the gradation determination signal ASW. The switch Pxb is turned on (conductive) and off (non-conductive), thereby to control connection/disconnection of the voltage source VOL to the video signal line X.

The switches Pxa and Pxb are formed of, for example, P-channel thin-film transistors. In this embodiment, the switches Pxa and Pxb are formed in the same fabrication steps with the same layer structure as the thin-film transistors of the pixel circuit 18. The switches Pxa and Pxb are constructed as top-gate thin-film transistors using polysilicon as semiconductor layers.

The controller 12 shown in FIG. 1 is formed on a printed circuit board which is disposed outside the organic EL panel 10. The controller 12 controls the scan line driving circuit 14 and signal line driving circuit 15. The controller 12 receives a digital video signal and a sync signal which are supplied from outside. On the basis of the sync signal, the controller 12 generates a vertical scan control signal which controls a vertical scan timing, and a horizontal scan control signal which controls a horizontal scan timing. The controller 12 supplies the vertical scan control signal and horizontal scan control signal to the scan line driving circuit 14 and signal line driving circuit 15, and also supplies the digital video signal to the signal line driving circuit 15 in sync with the horizontal and vertical scan timings. Based on the information of the digital video signal, the controller 12 determines whether the display gradation is high-gray-level display or low-gray-level display, as will be described later, and outputs the gradation determination signal ASW to the signal line driving circuit 15.

Under the control of the horizontal scan control signal, the signal line driving circuit 15 converts video signals, which are successively obtained in respective horizontal scan periods, to analog video signals, and supplies the analog video signals to plural video signal lines X (1 to n) in a parallel fashion. The scan line driving circuit 14 includes a shift register and an output buffer. The scan line driving circuit 14 successively transfers a horizontal scan start pulse, which is supplied from outside, to subsequent stages, and supplies two kinds of control signals, that is, control signals Sa (1 to m) and Sb (1 to m), to the display pixels Px of each row via the output buffer. Thereby, the first and second scan lines Sga and Sgb are driven by the control signals Sa and Sb in different 1-horizontal-scan periods.

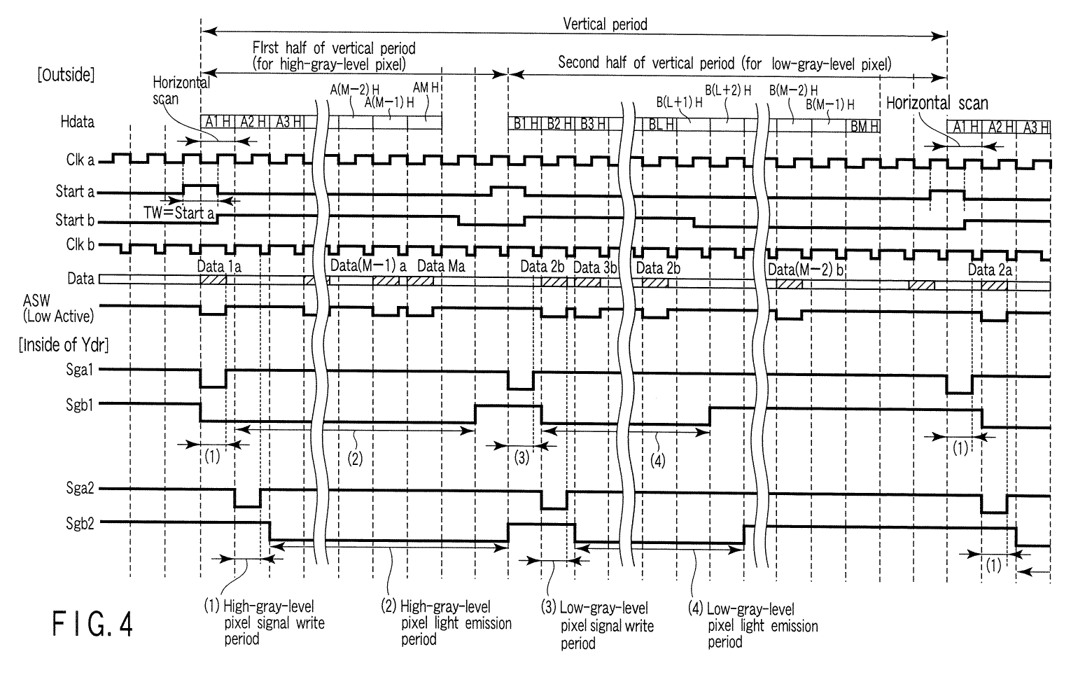

FIG. 4 is a timing chart of signals in the scan line driving circuit 14 and signal line driving circuit 15. The scan line driving circuit 14 includes a shift register, etc. which generates a pulse of a 1-horizontal-scan period (Tw-Start a) corresponding to each horizontal scan period on the basis of a start signal (Start a) and a clock a (Clk a). The scan line driving circuit 14 generates and outputs a control signal Sga on the basis of the generated pulse and a clock b (Clk b), and generates and outputs a control signal Sgb on the basis of the generated pulse.

In the organic EL display device, the operation of the pixel circuit 18 is divided into a video signal write operation and a light emission operation. As shown in FIG. 2, the scan line driving circuit 14 outputs a control signal Sal of a level (on-potential) (a low level in this example) which turns on the pixel switch 20 and first switch 24 of the display pixel Px on the first row. The scan line driving circuit 14 outputs a control signal Sb1 of a level (off-potential) (a high level in this example) which turns off the output switch 26. Thereby, the pixel switch 20 and first switch 24 are turned on (conductive) and the output switch 26 is turned off (non-conductive). Thus, the video signal write operation begins.

In a video signal write period, the signal line driving circuit 15 supplies a video signal current I_{A} corresponding to gradation to the associated video signal line X1. The video signal current I_{A} is supplied to the selected display pixel Px via the pixel switch 20. In the display pixel Px, the pixel switch 20 and first switch 24 are in the on-state, and the supplied video signal current I_{A} is delivered to the driving transistor 22 and renders the driving transistor 22 in the write state. Thereby, the write current flows to the video signal line X1 via the driving transistor 22 from the voltage supply line Vdd, and a gate-source potential of the driving transistor 22, which corresponds to the current amount of the video signal current I_{A} is written in the storage capacitance Cs.

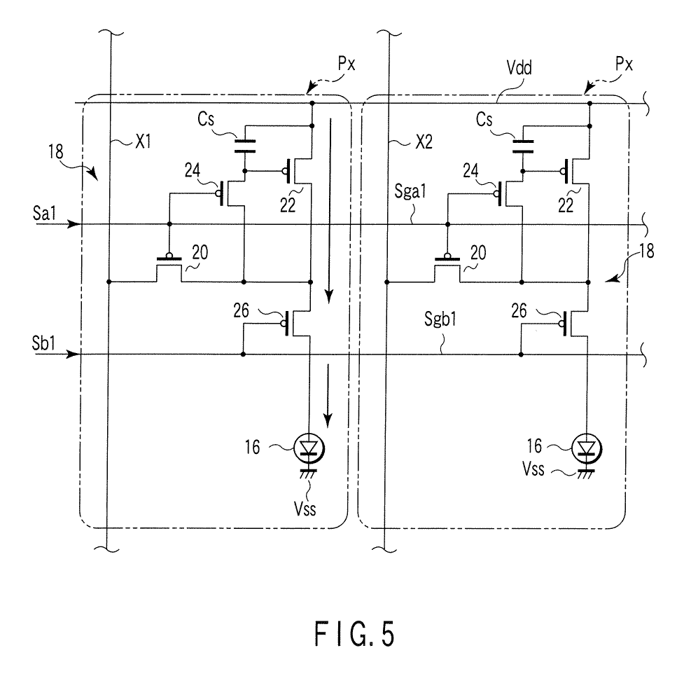

Subsequently, the control signal Sa1 is set in the high level (off-potential), and the pixel switch 20 and first switch 24 are turned off. Thus, the video signal write operation is completed. Then, the control signal Sb1 is set in the low level and the output switch 26 is turned on. Thereby, the light emission operation begins. As shown in FIG. 5, in a light emission period, the driving transistor 22 is kept in the on-state by the gate control voltage that is written in the storage capacitance Cs, and a current with an amount corresponding to the video signal current I_{A} is supplied from the voltage supply line Vdd to the organic EL element 16. Thereby, the organic EL element 16 emits light, and the light emission operation is started. The organic EL element 16 maintains the light emission state until the control signal Sb1 is restored to the off-potential.

As shown in FIG. 4, a 1 frame (vertical period) of image display is equally divided into a first-half 1 vertical period (i.e. a first period) in which a high-gray-level display pixel is to be driven, and a second-half 1 vertical period (i.e. a second period) in which a low-gray-level display pixel is to be driven. In the present embodiment, the low-gray-level display refers to a display mode in which the display pixel is driven by a video signal current of, e.g. 100 nA or less, and the high-gray-level display refers to a display mode in which the display pixel is driven by a video signal current which is higher than, e.g. 100 nA or less. A video signal current value, which is a boundary value between the low-gray-level display and the high-gray-level display, is not limited to 100 nA and can voluntarily be set.

In the first period, that is, the first-half period, the signal line driving circuit 15 supplies a high-gray-level display pixel Px, which is included in the plural display pixels Px, with a video signal having a current value which is several times (e.g. two times) higher than a current value corresponding to high-gray-level display. Thereby, the video signal is written in the high-gray-level display pixel Px (high-gray-level pixel signal write period (1)). At this time, the signal line driving circuit 15 supplies the video signal to the video signal line X from the current source CUR of the driving unit CirX which corresponds to each of high-gray-level display pixels. Specifically, if a gradation determination signal of a low level is input to the high-gray-level display pixel, the driving unit CirX turns on the switch Pxa via the inverters INVa and INVb. Thereby, the current source CUR is connected to the video signal line X, and the video signal current is supplied to the video signal line X. The other switch Pxb of the driving unit CirX is kept in the off-state, and the voltage source VOL is not connected to the video signal line X.

In the first period, following the signal write in the high-gray-level display pixel Px, the light emission operation of the high-gray-level display pixel is performed (high-gray-level pixel light emission period (2)).

In the second period, that is, the second-half period, if a gradation determination signal of a low level is input to the low-gray-level display pixel, the signal line driving circuit 15 supplies a low-gray-level display pixel Px, which is included in the plural display pixels Px, with a video signal having a current value which is N times (e.g. ten times) higher than a current value corresponding to low-gray-level display. Thereby, the video signal is written in the low-gray-level display pixel Px (low-gray-level pixel signal write period (3)). At this time, the signal line driving circuit 15 supplies the video signal to the video signal line X from the current source CUR of the driving unit CirX. In the second period, following the signal write in the low-gray-level display pixel Px, the light emission operation of the low-gray-level display pixel is performed (low-gray-level pixel light emission period (4)).

On the other hand, in the first period of 1 frame, a gradation determination signal of a high level is supplied to a display pixel Px in which no video signal is written by the current source CUR of the driving unit, that is, a low-gray-level display pixel Px. A video signal, which causes the display pixel Px to effect black display, is written in the low-gray-level display pixel Px via the associated video signal line X from the voltage source VOL of the driving unit CirX. Thereby, in the first period for high-gray-level display, the low-gray-level display pixel effects black display following the completion of the signal write.

In the second period, a gradation determination signal of a high level is supplied to a display pixel Px in which no video signal is written by the current source CUR of the driving unit, that is, a high-gray-level display pixel Px. A video signal, which causes the display pixel Px to effect black display, is written in the high-gray-level display pixel Px via the associated video signal line X from the voltage source VOL of the driving unit CirX. Thereby, in the second period for low-gray-level display, the high-gray-level display pixel effects black display following the completion of the signal write.

The length of the video signal write period (1) of the high-gray-level pixel and the length of the video signal write period (3) of the low-gray-level pixel are determined by the width of the clock b (Clk b), as in the prior art. Each of the periods (1) and (3) is set to be slightly shorter than 1 horizontal period. In the first period, the length of the light emission period (2) of the high-gray-level pixel and the length of the light emission period of the black display of the low-gray-level pixel are set to be equal to the first-half 1 vertical period, as in the prior art. In the second period, the length of the light emission period (4) of the low-gray-level pixel and the length of the light emission period of the black display of the high-gray-level pixel are set to be ⅕ of the second-half 1 vertical period. Specifically, the length of the light emission period (4) of the low-gray-level pixel is controlled in accordance with display gradation. In the present embodiment, the length of the light emission period (4) of the low-gray-level pixel is set to be 2/N (=⅕) of the 1 vertical period in accordance with the multiplication factor of the video signal current value of the high-gray-level display pixel and the multiplication factor N of the video of the video signal current value of the low-gray-level display pixel.

In order to prevent occurrence of flicker, the frame frequency is set at 60 Hz. In this case, the frequency of the signal in the scan line driving circuit 14 and signal line driving circuit 15 is set at double the frame frequency, i.e. 120 Hz.

According to the organic EL display device having the above-described structure, when the display pixel Px is caused to emit light at a low gray level, the video signal current having the current value, which is higher than the current value corresponding to gradation by a predetermined multiplication factor, e.g. 10, is supplied. Thereby, the wiring capacitance of the associated video signal line can sufficiently be charged/discharged. Accordingly, when the low-gray-level video signal is written in the display pixel Px, the signal write can sufficiently be performed in a short time without influence by the wiring capacitance. Therefore, visual recognition of display defects, non-uniform lines, graininess, etc. at low brightness can be prevented, and high-quality image display can be realized.

The 1 frame is divided into the first period and second period. In the first period, the high-gray-level display pixel is driven by the video signal current having the current value that is two times higher than the normal current value. In the second period, the low-gray-level display pixel is driven by the video signal current having the current value that is ten times higher than the normal current value. Further, the light emission time of the display element is controlled in accordance with gradation. Specifically, as regards the high-gray-level display pixel Px, the light emission time is set to be substantially equal to the first period, that is, the 1 vertical period in this embodiment. As regards the low-gray-level display pixel Px, the light emission time is set to be about ⅕ of the 1 vertical period. Therefore, even in the case where the high-gray-level display pixel and low-gray-level display pixel are driven by the video signal current having a current value that is several times higher than a normal current value, the display brightness in the entire 1 frame can be set at a desired value.

When the display pixel is caused to emit light at a high gray level, it is sufficient to set the input signal current value to be two times higher than the normal value. Thus, the load on the signal line driving circuit 15 including the current source CUR is only double or thereabout, and a great increase in power consumption can be prevented.

In the first period in which the high-gray-level display pixel is driven, the low-gray-level display pixel is caused to effect black display. In the second period in which the low-gray-level display pixel is driven, the high-gray-level display pixel is caused to effect black display. Thereby, the visibility at the time of motion video display can be improved. In usual cases, in the motion video display, the visibility deteriorates due to the effect of a retinal afterimage that occurs on the visual sense of the viewer. However, by inserting the black display as described above, the visibility can be improved by a discrete pseudo-impulse response of brightness.

As has been described above, according to the present embodiment, it is possible to obtain an active matrix display device which can perform a good display operation without being affected by a wiring capacitance, and can suppress power consumption, and a driving method for the active matrix display device.

The present invention is not limited directly to the embodiment described above, and its components may be embodied in modified forms without departing from the spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In the above-described embodiment, the high-gray-level display pixel is supplied with the video signal current having the current value that is two times higher than the normal current value, and the low-gray-level display pixel is supplied with the video signal current having the current value that is ten times higher than the normal current value. However, these multiplication factors are not limited to these values, and can arbitrarily be chosen according to the gradation.

The frame frequency is not limited to 60 Hz, and may be altered as needed. If no flicker occurs, the frame frequency may be set at 30 Hz, for instance. In this case, the signal write period can be set to be substantially equal to that in the prior art. Thereby, the wiring capacitance charging/discharging effect of the video signal line in the low-gray-level display can further be enhanced.

In the above embodiment, the thin-film transistors, which constitute the pixel circuit, and the thin-film transistors, which constitute the constant-current circuit, are all composed of transistors of the same conductivity type, i.e. P-channel type. Alternatively, all of these transistors may be composed of N-channel type thin-film transistors. In addition, the pixel circuit may be composed of thin-film transistors of different conductivity types. For example, the pixel switch and the first switch may be formed of N-channel type thin-film transistors, and the driving transistor may be formed of a P-channel type thin-film transistor.

The semiconductor layer of each thin-film transistor is not limited to polysilicon, and may be formed of amorphous silicon. The self-luminous element of the display pixel is not limited to the organic EL element, and various kinds of self-luminous display elements are applicable.

What is claimed is:

1. An active matrix display device comprising:
a plurality of pixel units which are arrayed in a matrix on a display region of a substrate, each pixel unit including a display element;
a plurality of scan signal lines which are connected to respective rows of the pixel units;
a plurality of video signal lines which are connected to respective columns of the pixel units;
a scan line driving circuit which supplies scan signals to the scan signal lines; and
a signal line driving circuit which divides a 1 frame into a first period in which a video signal is supplied to the pixel unit of a high gray level and a second period in which a video signal is supplied to the pixel unit of a low gray level, supplies in the first period a video signal current, which has a current value that is A-times (A>0) higher than a current value corresponding to high-gray-level display, to the pixel unit of the high gray level, and supplies in the second period a video signal current, which has a current value that is N-times (N>A) higher than a current value corresponding to low-gray-level display, to the pixel unit of the low gray level, thus writing the video signal in the pixel unit.

2. The display device according to claim 1, wherein the signal line driving circuit supplies in the first period a video signal corresponding to black display to the pixel unit of the low gray level, and supplies in the second period a video signal corresponding to black display to the pixel unit of the high gray level.

3. The display device according to claim 2, wherein the signal line driving circuit includes a plurality of driving units which are connected to the video signal lines, each of the driving units including a current source which supplies a video signal current, and a voltage source which supplies a video signal corresponding to the black display.

4. The display device according to claim 1, wherein light emission periods of the pixel unit of the low gray level and the pixel unit of the high gray level are controlled in accordance with gradation, and the light emission period of the pixel unit of the low gray level is set at A/N of the second period.

5. The display device according to claim 1, wherein each of the pixel units includes a driving transistor which supplies a driving current corresponding to the video signal current to the display element, a first switch connected between a gate and a drain of the driving transistor, an output switch which is connected in series to the display element and the driving transistor between constant voltage supplies, a storage capacitance which keeps constant a potential difference between the gate and a source of the driving transistor, and a pixel switch which controls selection/non-selection of the pixel unit,
the drain of the driving transistor being connected to the video signal line via the pixel switch.

6. The display device according to claim 1, wherein the driving transistor, the first switch, the output switch and the pixel switch are composed of thin-film transistors using polysilicon as semiconductor layers.

7. The display device according to claim 1, wherein the display element is a self-luminous element including an organic light-emitting layer between opposed electrodes.

8. A method of driving an active matrix display device including a plurality of pixel units which are arrayed in a matrix on a display region of a substrate, each pixel unit including a display element, a plurality of scan signal lines which are connected to respective rows of the pixel units, a plurality of video signal lines which are connected to respective columns of the pixel units, a scan line driving circuit which supplies scan signals to the scan signal lines, and a signal line driving circuit which supplies video signals to the video signal lines, the method comprising:
dividing a 1 frame into a first period in which a video signal is supplied to the pixel unit of high-gray-level display and a second period in which a video signal is supplied to the pixel unit of low-gray-level display;
supplying and writing in the first period a video signal current, which has a current value that is A-times (A>0) higher than a current value corresponding to the high-gray-level display, in the pixel unit of the high-gray-level display; and
supplying and writing in the second period a video signal current, which has a current value that is N-times (N>A) higher than a current value corresponding to the low-gray-level display, in the pixel unit of the low-gray-level display.

9. The method according to claim 8, wherein in the first period a video signal corresponding to black display is supplied to the pixel unit of the low-gray-level display, and in the second period a video signal corresponding to black display is supplied to the pixel unit of the high-gray-level display.
